(19) United States
(12) Patent Application Publication
(10) Pub. No.: US 2013/0305863 A1
(43) Pub. Date: Nov. 21, 2013

(54) METHOD OF OPERATING A PARK LOCK MECHANISM

(71) Applicants: Feisel Weslati, Troy, MI (US); Behrouz Ashrafi, Northville, MI (US)

(72) Inventors: Feisel Weslati, Troy, MI (US); Behrouz Ashrafi, Northville, MI (US)

(73) Assignee: CHRYSLER GROUP LLC, Auburn Hills, MI (US)

(21) Appl. No.: 13/476,221

(22) Filed: May 21, 2012

(51) Int. Cl. F16H 57/10

(52) U.S. Cl. 74/411.5

(57) ABSTRACT

A method of operating a park lock mechanism in a vehicle includes determining a force acting on a vehicle park lock mechanism when the vehicle is in park, and providing an offsetting force to counteract the force on the park lock mechanism before the vehicle is shifted out of park. In doing so, harshness and noise that may be associated with shifting a vehicle out of park, especially when the vehicle is parked on an incline, can be reduced or eliminated.

### FIELD

The present disclosure relates generally to a vehicle parking brake or lock system and more particularly to a method of operating a park lock mechanism.

### BACKGROUND

Vehicles transmissions have a park setting or gear in which the transmission may be locked and the vehicle turned off. When a vehicle is parked on a hill or other grade, gravitational forces on the vehicle provide a load on the vehicle park lock system. With such a load on the park lock system, disengagement of the park lock system to permit the transmission to be shifted out of park may be difficult or noisy or have a harsh movement.

### SUMMARY

A method of operating a park lock mechanism in a vehicle includes determining a force acting on a vehicle park lock mechanism when the vehicle is in park, and providing an offsetting force to counteract the force on the park lock mechanism before the vehicle is shifted out of park. In doing so, harshness and noise that may be associated with shifting a vehicle out of park, especially when the vehicle is parked on an incline, can be reduced or eliminated.

In at least one implementation, a method of providing an offsetting force to a park lock system in a vehicle includes providing an offsetting force on a transmission output shaft in a direction opposite to the force on the transmission output shaft due to the force of gravity on the vehicle. The offsetting force, in at least one example, can be applied without first determining the magnitude of the force needed, and the offsetting force can be applied until the net force on the park lock mechanism, or on the output shaft, is below a threshold.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a side view of one example of a park lock system in its disengaged or unlocked position where a park lock mechanism is not engaged with a park gear of a vehicle transmission;

FIG. 2 is a side view like FIG. 1 showing the park lock system in its engaged or locked position; and

FIG. 3 is a flow chart showing steps of a representative method for reducing the force on the park lock mechanism before the vehicle is shifted out of park.

### DETAILED DESCRIPTION

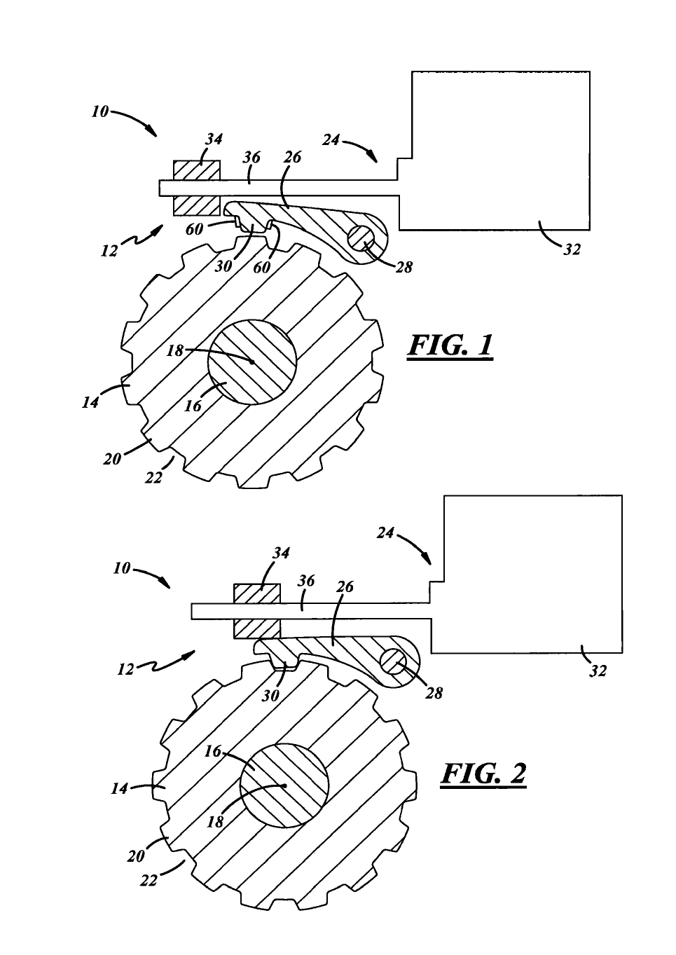

Referring in more detail to the drawings, FIGS. 1 and 2 illustrate a park lock system 10 for a vehicle. The park lock system 10 includes a lock mechanism 12 that engages a park gear 14 of the vehicle transmission to hold or lock the vehicle transmission in park. The lock mechanism 12 is removed or disengaged from the park gear 14 to permit the vehicle transmission to be shifted out of park and into another gear (e.g. reverse, neutral or a forward drive gear).

In more detail, as shown in FIGS. 1 and 2, the park gear 14 is coupled to a vehicle transmission output shaft 16 for rotation with the output shaft 16 about an axis 18 of the shaft when the vehicle is moving. The gear 14 has a plurality of circumferentially spaced apart teeth 20 extending outwardly around its periphery. Gaps 22 are defined between adjacent teeth 20 in an alternating pattern of teeth and gaps.

The park lock system 10 includes the lock mechanism 12 and an actuator 24 for selectively engaging the lock mechanism 12 with the park gear 14. In the example shown, the lock mechanism 12 includes a pawl 26 pivoted at a first end about a pin 28 to move a second end including a lock tab 30 toward and away from the park gear 14. This permits the pawl 12 to be moved between disengaged (FIG. 1) and engaged (FIG. 2) positions to selectively engage the pawl 26 with the park gear 14. The lock tab 30 is adapted to engage a tooth 20 of the park gear 14 when the park lock mechanism 10 is actuated to lock the vehicle transmission in park. The pawl 26 may be yieldably biased, such as by a spring, toward its disengaged position where the lock tab 30 is free and clear of the park gear 14 to permit rotation of the park gear 14. In this way, absent a force moving and holding the pawl 26 into its engaged position, the pawl 26 will normally be in its disengaged position.

The actuator 24 may include a motor 32 and a drive member 34 driven by the motor 32 to move the pawl 26 from its disengaged position to its engaged position. The motor 32 may be any suitable reversible electric motor 32. The motor 32 is coupled to a threaded spindle 36 to rotate the spindle in forward and reverse directions and thereby move the drive member 34. The drive member 34 travels along the spindle 36 in a direction dictated by the direction of rotation of the spindle 36. In the implementation shown, the drive member 34 moves toward the motor 32 when the spindle 36 is rotated in the forward direction and the drive member 34 moves away from the motor 32 when the spindle 36 is rotated in the reverse direction.

In use, to engage the park lock system 10 the motor 32 is driven in its forward direction. This moves the drive member 34 toward the motor 32 along the spindle 36 until the drive member 34 engages the park pawl 26. If the lock tab 30 of the pawl 26 is aligned with a gap 22 between adjacent teeth 20 in the park gear 14, the pawl 26 is moved to its engaged position with the lock tab 30 received between adjacent teeth 20 as shown in FIG. 2. To provide a force holding the park pawl 26 in its engaged position, the drive member 34 may remain engaged with the park pawl 26. Gravity or another force (e.g. engine or transmission force), will generally cause some movement of the vehicle and corresponding rotation of the park gear 14 to firmly engage the lock tab 30 with one of the teeth 20 on the park gear 14. This provides a positive stop to movement of the park gear 14.

To shift the vehicle out of park, the park pawl 26 must be moved to its disengaged position. To do this, the motor 32 is driven in its reverse direction and the drive member 34 moves away from the motor 32 and the pawl 26. As the drive member 34 disengages from the pawl 26, the return spring biasing the pawl 26 moves the pawl 26 toward its disengaged position until the lock tab 30 is free and clear of the park gear 14 and the park gear can rotate without interference from the park pawl.

At least when the vehicle is parked on an incline, the force of gravity on the vehicle will tend to rotate the park gear 14 against and firmly into engagement with the lock tab 30 of the park pawl 26. This can provide a significant force on the park pawl 26 such that when the park pawl 26 is moved to its disengaged position, the park pawl 26 may abruptly move out of its engaged position and a loud noise and abrupt (but usually slight) movement of the vehicle may occur. Noise may also be attributed to the sudden movement of the park gear 14 upon release of the park pawl 26. The noise and vehicle movement can be startling or unsettling to some people.

To reduce or eliminate the noise and/or sudden movement of the vehicle upon disengagement of the park pawl 26 from the park gear 14, a counterforce is provided to lessen (potentially reduce to zero) the force the park gear 14 places on the lock tab 30 at least when the vehicle is parked on a grade or incline above a threshold magnitude. The counterforce may be provided by an electric motor coupled to the output shaft 16. The electric motor may provide a torque that counters the force tending to rotate the shaft 16 such that the force the park gear 14 provides on the lock tab 30 is reduced. In this way, the park lock system 10 is readily adaptable to an electric vehicle application where such an electric motor coupled to the output shaft 16 is already available. Of course, the counterforce could be provided in other vehicles including those using a combustion engine where the offsetting torque could be provided by the engine itself, or by another prime mover including an electric motor, if desired.

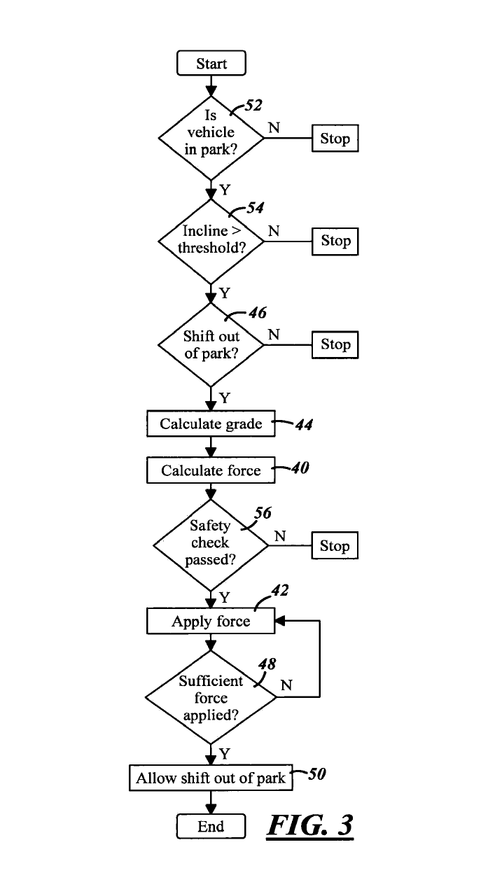

Accordingly, the park lock system 10 in operation may utilize any method of applying a counterforce or offsetting torque to lessen the force acting on the park lock mechanism 12 before the park lock mechanism 12 is disengaged from the park gear 14. In operation, one method of applying a counterforce is shown in the flow chart of FIG. 3. In general, that method for applying a counterforce or offsetting torque involves determining the amount of offsetting torque needed or desired at 40 and applying the determined torque to the shaft at 42. Of course, other methods may be used, for example, applying an offsetting torque to the shaft 16 until only a predetermined force remains on the park pawl 26 (that is, reducing the force on the park pawl 26 until the force is below a threshold). In another embodiment, the park pawl 26 and/or the drive member 34 can be configured so engaging surfaces cooperate to facilitate a smooth, uninterrupted engagement/disengagement of the contacting parts (26 and 34) and engagement/disengagement of the lock tab 30 with the park gear 14. For example, one or more contacting parts that engage/disengage may include a chamfered surface, curved surface profile, or otherwise complementary surface profile.

In more detail, the method of FIG. 3 includes a step 40 of determining the force acting on the park pawl 26. This may be accomplished in many ways. One way is to sense or determine a longitudinal acceleration of the vehicle (generally, the attitude or relative height of a front of the vehicle compared to the back end of the vehicle). The longitudinal acceleration may be measured using an inertial sensor such as an accelerometer or tilt sensor, by way of a couple examples, without any limitation intended. From the longitudinal acceleration, the grade or incline on which the vehicle is parked may be calculated at 44 and a suitable counteracting or offsetting torque can be calculated based on the grade where the force applied to the park pawl 26 at the calculated or determined grade is known or can be determined as a function of the vehicle weight.

Then, if there is a request 46 to shift the vehicle out of park and to another gear, the motor may be energized to provide the desired counteracting torque to the shaft 16. The counteracting torque applied can be sensed at 48, and when the desired counteracting torque, or a greater torque, has been applied to the shaft 16, the counteracting torque is no longer applied and the vehicle may then be shifted out of park at 50 and into another gear. A suitable controller, which may be a stand alone unit or part of an existing vehicle controller or control system, may be used to determine the offsetting force needed to be applied to the output shaft 16, and to control and monitor the application of the offsetting force to the output shaft 16.

Another way to determine the force on the park pawl 26 is to actually sense the force acting on the park pawl 26, such as with a strain gauge or other sensor. Such a force sensor 60 is shown diagrammatically in FIG. 1 on the lock tab and may be engaged by teeth 20 of the park gear 14 in use. After or while the offsetting force is provided, this force sensor 60 could also be used to determine when the force on the park pawl 26 has been reduced sufficiently to permit disengagement of the park pawl 26. Further, an initial determination of the magnitude of the load on the park pawl 26 is not needed. Instead, the offsetting force could be provided until the net force on the park pawl 26 is below a desired threshold. In other words, the magnitude of the offsetting force can be increased until the force on the park pawl 26 is decreased to a desired magnitude. In this example, an accelerometer or inclinometer could be used to determine the direction of the force to be applied to the output shaft 16 to offset the force on the park pawl 26 (where the direction will be different if the vehicle is parked with its front end facing uphill than if the vehicle is parked with its front end facing downhill).

Other steps may be included or substituted for steps identified in the representative flow chart and described method. For example, before beginning the method a determination can be made at 52 as to whether the vehicle is stationary and in park. If not, then no counteracting torque should be applied so the method should not be performed. Another step 54 may be to determine if the vehicle is parked on an incline that is greater than a threshold incline. The threshold incline can be chosen so that on inclines less than the threshold, the force on the pawl 26 will be within an acceptable range without any offsetting force applied to the output shaft 16 such that disengagement of the park pawl 26 will not cause unacceptable noise or vehicle movement. In this way, if the vehicle is not parked on a greater than threshold incline, then no offsetting force need be applied to the output shaft 16 and the method can be stopped.

Also, a system check may be provided at 56 before the counteracting torque is applied. The system check may include one or more steps designed to prevent application of the counteracting torque in certain conditions. For example, the system check may verify one or more of the following: 1) that the park lock is not already disengaged; 2) the vehicle currently is on a grade; 3) there is an operator request to disengage park; 4) the vehicle brake pedal has been/is applied (perhaps by sensing brake pedal switch(es) or receiving an indication from the system or vehicle ECU); 5) a signal indicative of the vehicle grade that was stored from the previous ignition cycle (e.g. when the vehicle engine or motor was shutoff) is within a threshold value of the current signal regarding the grade the vehicle is currently on; 6) the integrity of the indicated/signaled grade is verified (perhaps through a Controller Area network (CAN), Cyclic Redundancy Check (CRC) and/or Rolling Counter (RC) check; 7) a traction motor angular displacement is less than a threshold; and 8) that the counteracting torque applied (achieved torque) is within a threshold of the desired or calculated torque intended to be applied. In at least some implementations, the counteracting torque would not be applied if any of the above conditions were not satisfied. The system check could also verify that sufficient brake system pressure exists to hold the vehicle stationary if the park lock is disengaged, and that a hand brake has been applied before disengaging the park lock, if desired.

Of course, other method steps may be added or substituted for the steps shown in FIG. 3, and not all steps are needed in any desired method. Further, the steps could be done in a different sequence or in a different combination of steps to provide an offsetting torque to the output shaft or park gear.

Further, while a particular park lock mechanism 12 and system 10 are described, the method of providing an offsetting force to the transmission output shaft 16 could be used with any park lock mechanism 12 and system 10. That is, the electric motor driven system, including the drive member 34, pawl 26, etc, are not needed. The force on any type of vehicle park lock system 10 could be reduced by providing a counteracting or offsetting force or torque to the transmission output shaft 16 or park gear 14.

What is claimed is:

1. A method of operating a park lock mechanism in a vehicle, comprising:
determining a force acting on a vehicle park lock mechanism when the vehicle is in park; and
providing an offsetting force to counteract the force on the park lock mechanism before the vehicle is shifted out of park.

2. The method of claim 1, wherein the force acting on the vehicle park lock mechanism is determined as a function of the magnitude of an incline on which the vehicle is parked.

3. The method of claim 2, wherein the magnitude of the incline on which the vehicle is parked is determined by an accelerometer or inclinometer.

4. The method of claim 1, wherein the force acting on the vehicle park lock mechanism is sensed by a sensor.

5. The method of claim 1, wherein the vehicle includes a motor, a transmission shaft, and a park gear on the transmission shaft, and the park lock mechanism engages the park gear and wherein the offsetting force is provided directly to the transmission shaft by the motor.

6. The method of claim 1, wherein a determined offsetting force is applied before the vehicle transmission is shifted out of park.

7. The method of claim 6, wherein the magnitude of the offsetting force that has been applied is sensed to ensure at least the determined offsetting force has been applied before the vehicle transmission is shifted out of park.

8. The method of claim 1, wherein the offsetting force is applied to an output shaft of a vehicle transmission and the offsetting force is less than the force on the output shaft due to the force of gravity on the vehicle.

9. A method of operating a park lock system in a vehicle, comprising:
providing an offsetting force on a transmission output shaft in a direction opposite to the force on the transmission output shaft due to the force of gravity on the vehicle.

10. The method of claim 9, wherein the force is provided by an electric motor coupled to the output shaft.

11. The method of claim 9, which also comprises determining one or both of the direction and magnitude of the load on the output shaft due to the force of gravity on the vehicle.

12. The method of claim 11, wherein the offsetting force provided on the output shaft is less than the magnitude of the load on the output shaft due to the force of gravity on the vehicle.

13. The method of claim 11, wherein the magnitude of the load on the output shaft due to the force of gravity on the vehicle is determined as a function of the grade on which the vehicle is parked.

14. The method of claim 13, wherein the grade on which the vehicle is parked is determined with an accelerometer or inclinometer.

15. The method of claim 11, wherein the magnitude of the load on the output shaft due to the force of gravity on the vehicle is determined with a load sensor.

16. The method of claim 15, wherein the load sensor senses the load on the output shaft or the load applied to a park lock mechanism when the park lock mechanism is engaged with a park gear on the output shaft.
